(19) United States
(12) Patent Application Publication
(10) Pub. No.: US 2007/0099704 A1
(43) Pub. Date: May 3, 2007

(54) SYSTEM AND METEHOD FOR INTERACTIVE MOBILE NETWORK GAMING

(75) Inventors: Chuanli Liu, Chapel Hill, NC (US); Toby John Bowen, Durham, NC (US)

Correspondence Address: MOORE AND VAN ALLEN PLLC FOR SEMC, P.O. BOX 13706, 430 DAVIS DRIVE, SUITE 500, RESEARCH TRIANGLE PARK, NC, 27709, US

(73) Assignee: SONY ERICSSON MOBILE COMMUNICATIONS AB, Lund (US)

(21) Appl. No.: 11/163,883

(22) Filed: Nov. 2, 2005

(51) Int. Cl. A63F 9/24; G06F 19/00

(52) U.S. Cl. 463/42; 463/41

(57) ABSTRACT

A method of playing a game among portable mobile communications devices over a network wherein the game is hosted on a mobile game server that is communicable with the portable mobile communications devices via a mobile phone network and a mobile broadcast network is presented. The portable mobile communications devices receive control data signals from the mobile game server using a lower bandwidth cellular data services connection. The received control data signals contain a mobile game server control signal requesting input from the portable mobile communications device. The portable mobile communications device also sends control data signals to the mobile game server using the cellular data services connection. The sent control data signals contain portable mobile communications device player input sent from the portable mobile communications device to the mobile game server in response to the mobile game server requests. In addition, the portable mobile communications devices receive content data signals comprised of game updates from the mobile game server via the mobile broadcast network.

### BACKGROUND OF THE INVENTION

Portable mobile communications devices such as mobile phones are becoming more sophisticated and include many new features and capabilities. One such feature is the capability to receive mobile broadcast television signals or mobile television or the like, such as digital video broadcast-handheld (DVB-H), digital media broadcast (DMB), integrated services digital broadcast-terrestrial (ISDB-T) or similar technologies.

Another feature common to current portable mobile communications devices is the ability to play video games on the portable mobile communications device. Some of these video games can be played against multiple opponents over a network where each user plays a common game using their own portable mobile communications device. Current cellular data services have bandwidth capabilities that can limit the effectiveness and user satisfaction when playing a network game with multiple participants. This can be attributed to two primary factors. First, the bandwidth and data exchange rates of current cellular data services are below those of hardwired computer based systems such as Ethernet, USB, IEEE 1394, etc. They are also below that of shorter range wireless protocols such as WiFi, Wimax, 802.11x standards, as well as mobile broadcast systems like DVB-H, DMB, and cellular broadcast systems like Multimedia Broadcast/Multicast Service (MBMS). The second factor is that both the uplink and downlink data exchanges occur over the cellular data services connection whatever it may be.

What is needed is a system and/or method of enhancing the mobile network gaming user experience.

### BRIEF SUMMARY OF THE INVENTION

In accordance with an embodiment of the present invention, there is described a method of playing a game among portable mobile communications devices over a network wherein the game is hosted on a mobile game server that is communicable with the portable mobile communications devices via a mobile phone network and a mobile broadcast network. The mobile broadcast network can be any of those described above or later developed. The mobile broadcast network can be part of the mobile phone network or separate from the portable mobile communications device network. The portable mobile communications devices receive control data signals from the mobile game server using a lower bandwidth cellular data services connection. The received control data signals contain a mobile game server control signal requesting input from the portable mobile communications device. The portable mobile communications device also sends control data signals to the mobile game server using the cellular data services connection. The sent control data signals contain portable mobile communications device player input sent from the portable mobile communications device to the mobile game server in response to the mobile game server requests. In addition, the portable mobile communications devices receive content data signals comprised of game updates from the mobile game server via the mobile broadcast network.

### BRIEF DESCRIPTION OF THE DRAWINGS

FIG. 1 is a block diagram of an exemplary system for playing a video game over a network.

FIG. 2 is a block diagram of another exemplary system for playing a video game over a network.

FIG. 3 illustrates a series of screen shots for a sample video game being played over a network.

FIG. 4 is a logic diagram illustrating the messaging and data flow involved in playing a video game as shown in FIG. 3 over a system as shown in FIG. 1.

FIG. 5 is a logic diagram illustrating the messaging and data flow involved in playing a video game as shown in FIG. 3 over a system as shown in FIG. 2.

### DETAILED DESCRIPTION OF THE INVENTION

The following detailed description of embodiments refers to the accompanying drawings, which illustrate specific embodiments of the invention. Other embodiments having different structures and operations do not depart from the scope of the present invention.

As will be appreciated by one of skill in the art, the present invention may be embodied as a method, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

Any suitable computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention provides a means for enhancing the mobile network gaming user experience by sending uplink game data from the portable mobile communications device to the network game server using typical cellular data services and receiving downlink game data over a broadcast network such as, for instance, a mobile television broadcast system or a higher bandwidth cellular broadcast system. Broadcast systems by definition are one way. A single entity sends out data to multiple receivers. The bandwidth of a broadcast system is typically much higher than that of a 2-way cellular data service such as GPRS, EDGE, or the like.

By separating the uplink and downlink control signals and downlink content data onto separate networks and utilizing a higher bandwidth broadcast system to accommodate larger volumes of data for downlink content data communications and a lower bandwidth cellular services link for uplink and downlink of control signals, the user experience of a mobile network game is enhanced.

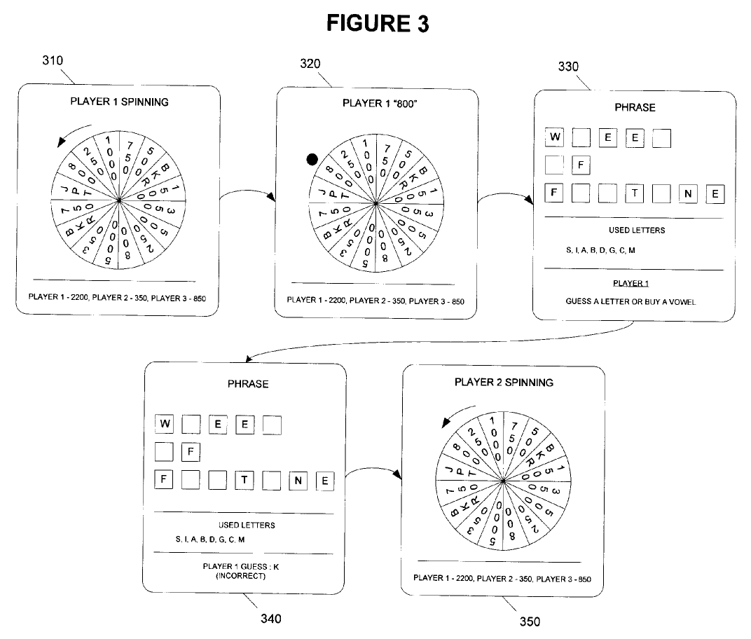

The system described herein applies to mobile games that share a common display to all users/players since a single downlink broadcast update is sent to all players at the appropriate time. This will become more evident when describing the logic diagram of FIG. 3.

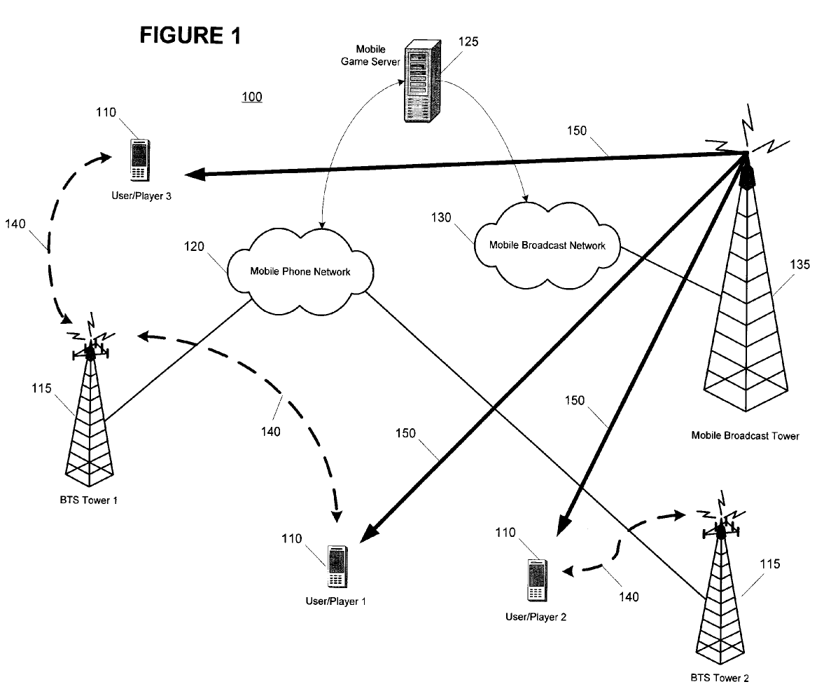

FIG. 1 is a block diagram of an exemplary system 100 for playing a video game over a network. The block diagram describes an environment in which multiple portable mobile communications devices 110 can simultaneously play a video game with and against one another using one data communication means for control signal uplink and downlink and another data communication means for downlink broadcasted content. Each portable mobile communications device 110 is wirelessly communicable with a mobile phone network 120 via its nearest basestation tower 115. The mobile phone network 120 is also communicable with a mobile game server 125. The mobile game server 125 can reside within the mobile phone network 120 or stand alone on a separate network or platform so long as the mobile game server 125 can exchange data with the mobile phone network 120. The mobile game server 125, in turn, is communicable with a mobile broadcast network 130 such as for instance, digital video broadcast-handheld (DVB-H), digital media broadcast (DMB), integrated services digital broadcast-terrestrial (ISDB-T) or similar technologies. The portable mobile communications devices 110 can receive data broadcast from the mobile broadcast network 130 via a broadcast tower 135.

Thus, the portable mobile communications devices 110 send and receive control signals to and from the mobile game server 125 via the mobile phone network 120 using cellular data services and receive broadcast data from the mobile game server 125 via a mobile broadcast network 130 separately.

The portable mobile communications device(s) 110 include an operator or user interface to facilitate controlling operation of the portable mobile communications device(s) 110 including initiating and conducting phone calls and other communications. The user interface may include a display to provide visual signals to a subscriber, viewer, or user as to the status and operation of the portable mobile communications device(s) 110. The display may be a liquid crystal display (LCD) or the like capable of presenting color images. The display may provide information to a user or operator in the form of images, text, numerals, characters, a graphical user interface (GUI) and the like.

The user interface may also include a keypad and function keys or buttons including a pointing device, such as a joystick or the like. The keypad, function buttons and/or joystick permit the user to communicate commands to the portable mobile communications device(s) 110 to dial phone numbers, initiate and terminate calls, establish other communications, such as access a mobile TV provider, the Internet, send and receive email, text messages and the like. The keypad, function buttons, and/or joystick may also be used to control other operations of the portable mobile communications device(s) 110 such as providing gaming input. The keypad, function buttons, and/or joystick may also be implemented and combined on a touch sensitive display to receive tactile input.

The display, keypad, and function buttons may be coupled to a main processor and control logic unit within the portable mobile communications device(s) 110. The processor and control logic unit may be a microprocessor or the like.

The user interface 110 may also include a microphone and a speaker. The microphone may receive audio or acoustic signals from a user or from another acoustic source. The microphone may convert the audio or acoustic signals to electrical signals. The microphone may be connected to the processor and logic unit wherein the processor and logic unit may convert the electrical signals to baseband communication signals. The processor and control logic unit may be connected to a radio transmitter that may convert baseband signals from the processor and control logic unit to radio frequency (RF) signals. The radio transmitter may be connected to an antenna assembly for transmission of the RF signals to a communication medium or system, such as a mobile radio access network (MRAN) or the like.

The antenna assembly may receive RF signals over the air and transfer the RF signals to a radio receiver. The radio receiver may convert the RF signals to baseband signals. The baseband signals may be applied to the processor and control logic unit which may convert the baseband signals to electrical signals. The processor and control unit may send the electrical signals to the speaker which may convert the electrical signals to audio signals that can be understood by the user.

The portable mobile communications device(s) 110 may also include a mobile broadcast receiving device. The mobile broadcast receiving device may be a DVB-H type device or the like. The mobile broadcast receiving device may be integrally formed as part of the portable mobile communications device(s) 110 or may be a separate unit that may be connected and operate in association with the portable mobile communications device(s) 110. The mobile broadcast receiving device may include an antenna assembly for receiving broadcast signals from a mobile broadcast network 130 or the like. A receiver may be coupled to the antenna assembly to receive the broadcast signals. A signal processor may receive the broadcast signals from the receiver and convert the signals to a format for video presentation on the display and audio output on speaker of the portable mobile communications device(s) 110.

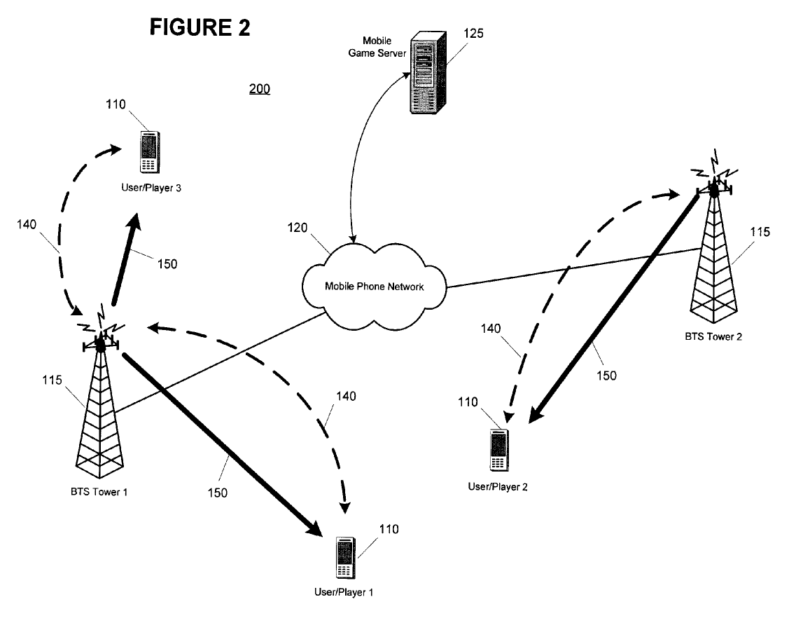

FIG. 2 is a block diagram of another exemplary system 200 for playing a video game over a network. This block diagram also describes an environment in which multiple portable mobile communications devices 110 can simultaneously play a video game with and against one another using one data communication means for uplink and downlink of control signals and another data communication means for downlink of broadcast content signals. For uplink and downlink of control signals communications, each portable mobile communications device 110 is wirelessly communicable with a mobile phone network 120 via its nearest basestation tower 115. The mobile phone network 120 is also communicable with a mobile game server 125. The mobile game server 125 can reside within the mobile phone network 120 or stand alone on a separate network or platform so long as the mobile game server 125 can exchange data with the mobile phone network 120.

For broadcast content downlink communications, the mobile game server 125 uses a cellular broadcast (e.g., MBMS) platform (as opposed to cellular data services) to broadcast game updates to the portable mobile communications devices 110 via the basestation towers 115. Thus, the portable mobile communications devices 110 send and receive control signals to and from the mobile game server 125 via the mobile phone network 120 using cellular data services and receive cellular broadcasts such as MBMS for the downlink of content data.

FIG. 3 illustrates a series of screen shots for a sample video game being played over a network. This example illustrates a version of the popular television game show “Wheel of Fortune” as played on a mobile device over a network with three players. The illustrations in FIG. 3 depict a series of screen shots as shown on a portable mobile communications device display for a “Wheel of Fortune” game already in progress. The first screen shot 310 shows a picture of the wheel as it is spinning. The top caption informs the players that player 1 has spun the wheel. The bottom caption keeps the current status of each player in terms of points or dollars they have accumulated up to this point in the game. Screen shot 310 is broadcast to all players so that each player receives the same view. Screen shot 320 illustrates the result of the spinning wheel from screen shot 310. In screen shot 320, a marker is placed adjacent to the “800” wedge of the wheel to indicate that the wheel stopped spinning with a marker for player 1 at the “800” wedge. The top caption informs the players that player 1 has indeed landed on the “800” wedge. The bottom caption remains unchanged since player 1 has yet to secure the 800 points or dollars resulting from his spin. Screen shot 330 is an image of the puzzle for this game. The puzzle is simply a series of letters arranged as words in which the words can be categorized as, for instance, a phrase, a movie title, a song, a persons name, a place, etc. The object is to guess enough letters so that you can figure out the entire phrase before your opponents. In screen shot 330, it is known that the puzzle is a “phrase” from the top caption. The phrase is comprised of three words of five, two, and seven letters respectively. Some of the letters have been revealed in the puzzle. In addition, there is a section of the display that keeps track of letters already guessed. Lastly, the bottom caption instructs player 1 to guess a new letter. Player 1 would input his letter guess which would be processed accordingly. In screen shot 340, player 1's guess is revealed as well as its result. In this case, player 1 guessed the letter “K” which has been determined to be incorrect in that it is not one of the letters in the puzzle phrase. The last screen shot 350 of this sequence indicates that control shifts from player 1 to player 2. Screen shot 350 is the same as screen shot 310 except player 2 is now the active player spinning the wheel. The game continues until one of the player successfully guesses the puzzle correctly.

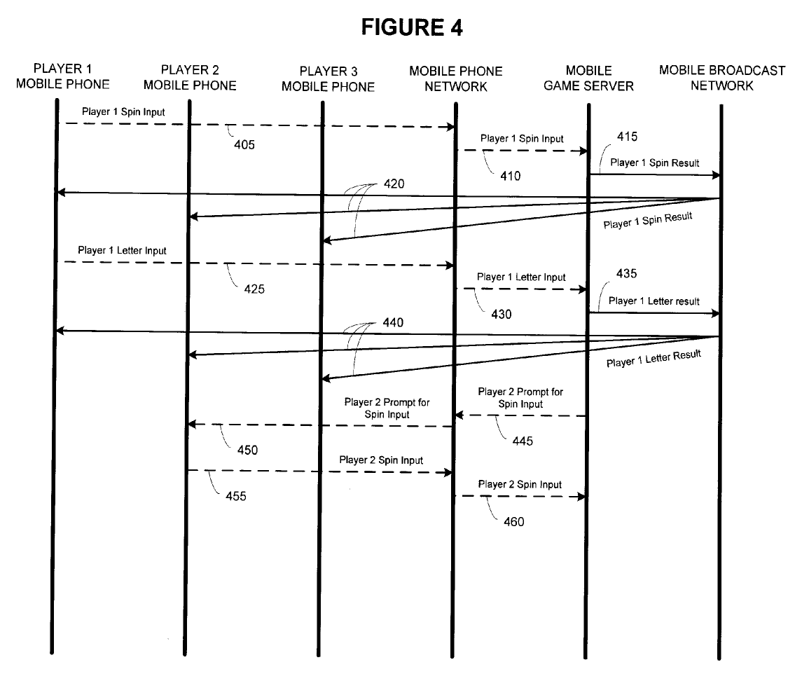

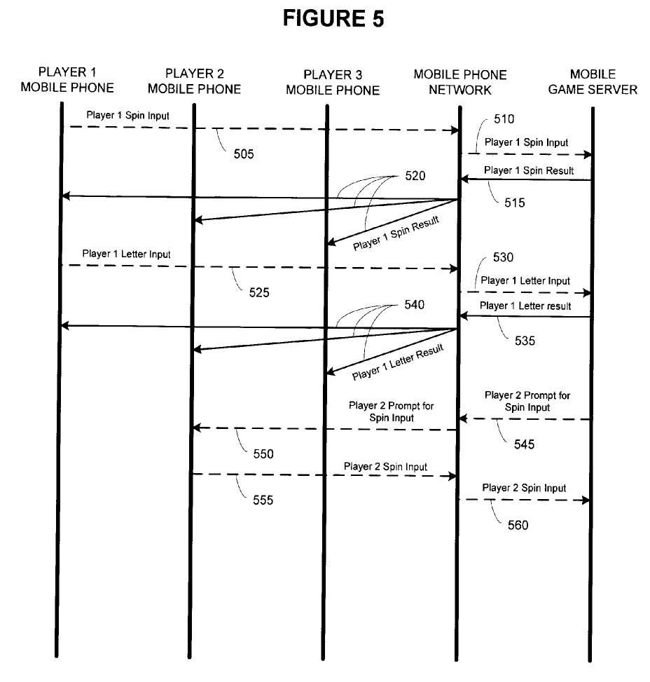

FIG. 4 is a logic diagram illustrating the messaging and data flow involved in playing a video game as shown in the sequence of FIG. 3 over a system as shown in FIG. 1. In FIGS. 4 and 5 dashed lines represent control data signals while solid lines represent broadcast content data signals. Control signals in general do not contain much data and can be efficiently sent and received over a cellular data services type connection. Content signals, however, contain much more data and benefit greatly from using a higher bandwidth broadcast medium to send mobile game data to all players simultaneously as opposed to separate content signals to each portable mobile communications device.

The first control data signal shown in FIG. 4 is a carries player 1's control input 405 from his portable mobile communications device to the mobile phone network causing the wheel to spin. This refers back to screen shot 310 of FIG. 3. This control signal is carried over a lower bandwidth cellular data services connection between the portable mobile communications device and the portable mobile communications device network. From there, the control signal is forwarded 410 to a mobile game server that actually hosts and processes the mobile game action. The mobile game server processes the spin input to obtain a spin result which is forwarded 415 to a mobile television broadcast network. The mobile broadcast network receives the spin result with instructions to broadcast the result 420 out to the portable mobile communications devices of the players involved in the current game. Each player's portable mobile communications device then receives the updated broadcast of the games status that corresponds to screen shot 320 of FIG. 3. Next, player 1 is asked to input a letter as shown in screen shot 330 of FIG. 3. Player 1's letter input is forwarded as a control signal 425 to the mobile phone network and then on to 430 the mobile game server. The letter input is processed by the mobile game server with the result forwarded 435 to the mobile television broadcast network. The result is then broadcast 440 back out to the portable mobile communications devices of the players involved in the current game yielding screen shot 340 of FIG. 3. Since the result causes player 1 to lose his turn according to the rules of the game, the mobile game server sends a control signal 445 to player 2's portable mobile communications device by way of the mobile phone network 450 instructing player 2 to “spin the wheel”. Player 2 responds by selecting the input mechanism on his portable mobile communications device that causes the wheel to spin once another control signal is sent 455 from the portable mobile communications device to the mobile phone network and then on to 460 the mobile game server.

The mobile game server continues to process input and update the game status according to the input. Content updates continue to be sent out over the mobile broadcast network while individual control signals are exchanged directly with the affected portable mobile communications devices using a cellular data services connection.

FIG. 5 is a logic diagram illustrating the messaging and data flow involved in playing a video game as shown in the sequence of FIG. 3 over a system as shown in FIG. 2. The chief difference between FIGS. 4 and 5 is that a high bandwidth mobile broadcast system hosted and run by the mobile phone network is used in place of a mobile television broadcast network. The concept remains the same however, namely, control signals are exchanged between the mobile game server and the affected portable mobile communications devices using a cellular data services connection while content updates are sent from the mobile game server over a higher bandwidth broadcast connection to the portable mobile communications devices.

Thus, the first control data signal shown in FIG. 5 carries player 1's control input 505 from his portable mobile communications device to the mobile phone network causing the wheel to spin. This refers back to screen shot 310 of FIG. 3. This control signal is carried over a lower bandwidth cellular data services connection between the portable mobile communications device and the portable mobile communications device network. From there, the control signal is forwarded 510 to a mobile game server that actually hosts and processes the mobile game action. The mobile game server processes the spin input to obtain a spin result that is sent back 515 to the mobile phone network to be broadcast out 520 to the portable mobile communications devices of the players involved in the current game. Each player's portable mobile communications device then receives the updated broadcast of the games status that corresponds to screen shot 320 of FIG. 3. Next, player 1 is asked to input a letter as shown in screen shot 330 of FIG. 3. Player 1's letter input is forwarded as a control signal 525 to the mobile phone network and then on to 530 the mobile game server. The letter input is processed by the mobile game server with the result forwarded 535 to the portable mobile communications device network. The result is then broadcast 540 by the mobile phone network back out to the portable mobile communications devices of the players involved in the current game yielding screen shot 340 of FIG. 3. Since the result causes player 1 to lose his turn according to the rules of the game, the mobile game server sends a control signal 545 to player 2's portable mobile communications device by way of the mobile phone network 550 instructing player 2 to “spin the wheel”. Player 2 responds by selecting the input mechanism on his portable mobile communications device that causes the wheel to spin once another control signal is sent 555 from the portable mobile communications device to the mobile phone network and then on to 560 the mobile game server.

Again, the mobile game server continues to process input and update the game status according to the input. Content updates continue to be sent out over the mobile phone network using a higher bandwidth broadcast system while individual control signals are exchanged directly with the affected portable mobile communications devices using a cellular data services connection.

Higher bandwidth cellular data services connections may include, but are not limited to, EDGE, UMTS, HSPDA, and EV-DO. Please note that as third generation cellular technologies evolve, current higher bandwidth cellular data services connections may become relatively lower bandwidth in the future. Thus, the present invention is intended to convey the idea of using a separate higher bandwidth broadcast system to send out content data updates in a mobile gaming environment while using a different cellular data services connection for the exchange of control signals requiring significantly less bandwidth between the mobile game server and the portable mobile communications device.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Although specific embodiments have been illustrated and described herein, those of ordinary skill in the art appreciate that any arrangement which is calculated to achieve the same purpose may be substituted for the specific embodiments shown and that the invention has other applications in other environments. This application is intended to cover any adaptations or variations of the present invention. The following claims are in no way intended to limit the scope of the invention to the specific embodiments described herein.

What is claimed is:

1. A method of playing a game on a portable mobile communications device with other portable mobile communications devices over a network wherein the game is hosted on a mobile game server that is communicable with the portable mobile communications devices via a mobile phone network and a separate mobile broadcast network, the method comprising:
receiving control data signals in a portable mobile communications device from the mobile game server using a lower bandwidth cellular data services connection wherein the received control data signals contain a mobile game server control signal requesting input from the portable mobile communications device;
sending control data signals from a portable mobile communications device to the mobile game server using a lower bandwidth cellular data services connection wherein the sent control data signals contain player input sent from the portable mobile communications device to the mobile game server in response to the mobile game server control signal requesting such input; and
receiving content data signals comprised of game updates from the mobile game server by way of the mobile broadcast network.

2. A method of playing a game on a portable mobile communications device with other portable mobile communications devices over a network wherein the game is hosted on a mobile game server that is communicable with the portable mobile communications devices via a portable mobile communications device network, the mobile phone network including a mobile broadcast network, the method comprising:
receiving control data signals in a portable mobile communications device from the mobile game server using a lower bandwidth cellular data services connection wherein the received control data signals contain a mobile game server control signal requesting input from the portable mobile communications device;
sending control data signals from a portable mobile communications device to the mobile game server using a lower bandwidth cellular data services connection wherein the sent control data signals contain player input sent from the portable mobile communications device to the mobile game server in response to the mobile game server control signal requesting such input; and
receiving content data signals comprised of game updates from the mobile game server by way of the mobile broadcast network.

3. A system for playing a game on a portable mobile communications device with other portable mobile communications devices over a network wherein the game is hosted on a mobile game server that is communicable with the portable mobile communications devices via a mobile phone network and a mobile broadcast network, the system comprising:
a portable mobile communications device communicable with a mobile phone network via a cellular data services connection and capable of receiving broadcasts from a mobile broadcast network, the portable mobile communications device for:
receiving control data signals from the mobile game server via the mobile phone network using the cellular data services connection wherein the received control data signals contain a mobile game server control signal requesting input from the portable mobile communications device; and
sending control data signals to the mobile game server via the mobile phone network using the cellular data services connection wherein the sent control data signals contain player input sent in response to a mobile game server control signal requesting such input; and receiving content data signals comprised of game updates from the mobile game server via the mobile broadcast network.

4. A computer program product for playing a game on a portable mobile communications device with other portable mobile communications devices over a network wherein the game is hosted on a mobile game server that is communicable with the portable mobile communications devices via a mobile phone network and a separate mobile broadcast network, the computer program product comprising:
computer program code for receiving control data signals in a portable mobile communications device from the mobile game server using a lower bandwidth cellular data services connection wherein the received control data signals contain a mobile game server control signal requesting input from the portable mobile communications device;
computer program code for sending control data signals from a portable mobile communications device to the mobile game server using a lower bandwidth cellular data services connection wherein the sent control data signals contain player input sent from the portable mobile communications device to the mobile game server in response to the mobile game server control signal requesting such input; and
computer program code for receiving content data signals comprised of game updates from the mobile game server by way of the mobile broadcast network.

5. A computer program product for playing a game on a portable mobile communications device with other portable mobile communications devices over a network wherein the game is hosted on a mobile game server that is communicable with the portable mobile communications devices via a portable mobile communications device network, the mobile phone network including a mobile broadcast network, the computer program product comprising:
computer program code for receiving control data signals in a portable mobile communications device from the mobile game server using a lower bandwidth cellular data services connection wherein the received control data signals contain a mobile game server control signal requesting input from the portable mobile communications device;
computer program code for sending control data signals from a portable mobile communications device to the mobile game server using a lower bandwidth cellular data services connection wherein the sent control data signals contain player input sent from the portable mobile communications device to the mobile game server in response to the mobile game server control signal requesting such input; and
computer program code for receiving content data signals comprised of game updates from the mobile game server by way of the mobile broadcast network.
